(19) United States
(12) Patent Application Publication
(10) Pub. No.: US 2020/0220396 A1
(43) Pub. Date: Jul. 9, 2020

(54) STATOR CORE AND ROTATING ELECTRIC MACHINE

(71) Applicant: HONDA MOTOR CO., LTD., Tokyo (JP)

(72) Inventor: Kenta Uchida, Wako-shi (JP)

(21) Appl. No.: 16/729,623

(22) Filed: Dec. 30, 2019

(30) Foreign Application Priority Data
Jan. 9, 2019 (JP) 2019-002160

(51) Int. Cl. H02K 1/16

(52) U.S. Cl. CPC H02K 1/16; H02K 2201/09

(57) ABSTRACT

A stator core has a core plate group extracted as a group in a plurality of rows from a single steel plate and includes an identification portion provided on an outer periphery of the stator core and serving as turning lamination identification and row identification. At least one of a shape and a position of the identification portion in the stator core having at least one row of the core plate group is different from that in the stator core having another row of the core plate group.

### CROSS-REFERENCE TO RELATED APPLICATION

Priority is claimed on Japanese Patent Application No. 2019-002160, filed Jan. 9, 2019, the content of which is incorporated herein by reference.

### BACKGROUND OF THE INVENTION

### Field of the Invention

The present invention relates to a stator core and a rotating electric machine.

### Description of Related Art

Conventionally, a constitution of a laminated core, such as a stator core of a stator or a rotor core of a rotor used in a rotating electric machine, which is formed by punching a strip-shaped steel plate into a predetermined shape and laminating a plurality of steel plates is known. In such a laminated core, turning lamination in which the steel plates are sequentially rotated or turned and then laminated is performed to cancel out deviations of a thickness of the steel plate. Therefore, various techniques for determining whether or not turning lamination has been correctly performed have been proposed.

For example, Japanese Unexamined Patent Application, First Publication No. 2012-147597 (hereinafter, referred to as Patent Document 1) describes a constitution of a core plate in which an identification shape portion is provided in one of a plurality of window portions and an adjustment shape portion is provided in another one window portion. The identification shape portion is constituted by a concave portion in which a shape of the window portion on the inner diameter side is partially cut out, and the adjustment shape portion is configured by two concave portions in which the shape of the window portion on the inner diameter side is partially cut out. The identification shape portion and the adjustment shape portion are disposed symmetrically with respect to a central axis of the core plate, and a mass of the concave portion in which the adjustment shape portion is cut out is set to be the same as that of the concave portion in which the identification shape portion is cut out. Thus, the presence or absence of turning lamination can be easily and clearly identified without changing a position of a center of mass of the rotor.

### SUMMARY OF THE INVENTION

However, in the technique described in Patent Document 1, since the identification shape portion is formed on the inner diameter side of the window portion, it is difficult to visually confirm the turning lamination. Further, when punching is performed in a plurality of rows constituted by the strip-shaped steel plate, it is necessary to further provide a row identification shape for identifying which row has been punched from. Therefore, a decrease in performance of the laminated core due to an increase in the number of processes and formation of a plurality of cutouts may occur.

An aspect according to the present invention is in view of the above-described circumstances, and an object thereof is to provide a stator core which is able to be easily manufactured while curbing an increase in manufacturing costs and a decrease in performance, and a rotating electric machine using the stator core.

In order to solve the above problems and to achieve the object, the present invention employs the following aspects:

(1) A stator core according to one aspect of the present invention is a stator core having a core plate group extracted as a group in a plurality of rows from a single steel plate, including an identification portion provided on an outer periphery of the stator core and serving as turning lamination identification and row identification, wherein at least one of a shape and a position of the identification portion in the stator core having at least one row of the core plate group is different from that in the stator core having another row of the core plate group.

(2) In the aspect of (1), the identification portion may be recessed inside the stator core.

(3) In the aspect of (1), the identification portion may protrude outside the stator core.

(4) A rotating electric machine according to one aspect of the present invention includes one of the aspects of (1) to (3).

According to the aspect of (1), since the identification portion serves as turning lamination identification and row identification, it is possible to identify, by the identification portion, whether or not turning lamination has been performed correctly and which row of the steel plate the core plate group has been extracted from. Since the identification portion serves as row identification, it is not necessary to provide a cutout shape or the like for row identification additionally in the stator core. Thus, the number of processes for manufacturing the stator core and manufacturing costs such as mold costs can be reduced, as compared with a case in which both a turning lamination identification shape and a row identification shape are formed on the stator core. Furthermore, since it is not necessary to form an extra cutout or the like which obstructs formation of a magnetic path in the stator core, an area of the stator core can be increased, and thus an area through which the magnetic path passes can be increased. Accordingly, a decrease in performance of a stator due to obstruction of the magnetic path of the stator core can be curbed.

Since the identification portion is formed in an outer peripheral portion of the stator core, when a plurality of core plates are rotated and laminated in a thickness direction, the identification portion can be visually recognized from the outer peripheral portion of the stator core. Therefore, determination as to whether or not turning lamination has been performed correctly can be easily confirmed from the outside. Thus, workability at the time of manufacturing the stator core can be improved.

Therefore, it is possible to provide the stator core which can be easily manufactured while an increase in manufacturing costs and a decrease in performance are curbed.

According to the aspect of (2), since the identification portion is recessed inside the stator core, the outer peripheral portion of the stator core formed by turning and laminating a plurality of core plates can be formed in a smooth shape, as compared to a case in which the identification portion protrudes outward. Thus, operability at the time of manufacture and an external appearance can be improved.

According to the aspect of (3), since the identification portion protrudes outside the stator core, it is possible to perform the row identification and the turning lamination identification simply by touching the outer peripheral portion of the stator core formed by turning and laminating the plurality of core plates. In addition, a degree of freedom in an identification work method can be improved, for example, by automating the identification work using a contact type inspection device.

Further, the area for the stator core can be ensured as compared with a case in which the identification portion is formed to be recessed inside the stator core. Thus, an area through which a magnetic path formed in the stator can pass is increased, and an influence on the magnetic path due to formation of the identification portion can be curbed.

According to the aspect of (4), since the above-described stator core is provided, it is possible to provide a rotating electric machine having excellent manufacturability and performance and including a stator core which is easily manufactured while an increase in manufacturing costs and a decrease in performance are curbed.

### BRIEF DESCRIPTION OF THE DRAWINGS

FIG. 1 is a schematic cross-sectional view of a rotating electric machine according to a first embodiment.

FIG. 2 is a perspective view of a first stator core according to the first embodiment.

FIG. 3 is a perspective view of a second stator core according to the first embodiment.

FIG. 4 is an explanatory diagram showing a positional relationship between a steel plate and each of core plates according to the first embodiment.

FIG. 5 is a front view of a first core plate according to the first embodiment.

FIG. 6 is a front view of a second core plate according to the first embodiment.

FIG. 7 is a front view of a second core plate according to a second embodiment.

FIG. 8 is a front view of a first core plate according to a third embodiment.

FIG. 9 is a front view of a first core plate according to a fourth embodiment.

### DETAILED DESCRIPTION OF THE INVENTION

Hereinafter, embodiments of the present invention will be described with reference to the drawings.

### First Embodiment

(Rotating electric machine)

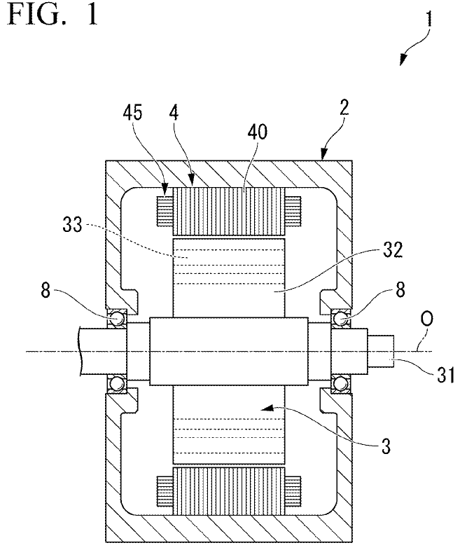

FIG. 1 is a schematic cross-sectional view of a rotating electric machine 1 according to a first embodiment.

The rotating electric machine 1 shown in FIG. 1 is a driving motor mounted in a vehicle such as a hybrid vehicle or an electric vehicle. However, a constitution of the present invention is not limited to a driving motor and can be applied to a power generation motor, a motor for other uses, and a rotating electric machine (including a generator) other than for a vehicle.

The rotating electric machine 1 includes a case 2, a rotor 3, and a stator 4.

The case 2 accommodates a rotor 3 and a stator 4. A refrigerant (not shown) is accommodated in the case 2. The above-described rotor 3 and stator 4 are disposed inside the case 2 in a state in which a part thereof is immersed in the refrigerant. An automatic transmission fluid (ATF) which is a working fluid used for lubrication of a transmission, power transmission, or the like is preferably used as the refrigerant.

In the following description, a direction along an axis O of a rotating shaft 31 in the rotor 3 may be simply referred to as an axial direction, a direction orthogonal to the axis O may be referred to as a radial direction, and a direction around the axis O may be referred to as a circumferential direction.

The rotor 3 is constituted to be rotatable around the axis O. The rotor 3 includes a rotating shaft 31, a rotor core 32, and a magnet 33.

The rotating shaft 31 is formed in a cylindrical shape centered on the axis O. The rotating shaft 31 is rotatably supported by the case 2 via a bearing 8 mounted on the case 2.

The rotor core 32 is provided on an outer peripheral portion of the rotating shaft 31. The rotor core 32 is formed in an annular shape. The rotor core 32 is constituted to be rotatable integrally with the rotating shaft 31 around the axis O.

The magnet 33 is disposed on an outer peripheral portion of the rotor core 32. For example, the magnet 33 extends in the axial direction inside the rotor core 32. A plurality of magnets 33 are formed at intervals in the circumferential direction. The magnet 33 is a rare earth magnet, for example. Examples of rare earth magnets include neodymium magnets, samarium cobalt magnets, praseodymium magnets, and the like.

### (Stator)

The stator 4 is disposed outward in the radial direction with respect to the rotor 3 with a gap therebetween. The stator 4 is formed in an annular shape. An outer peripheral portion of the stator 4 is fixed to an inner wall surface of the case 2. The stator 4 includes a stator core 40 and a coil 45.

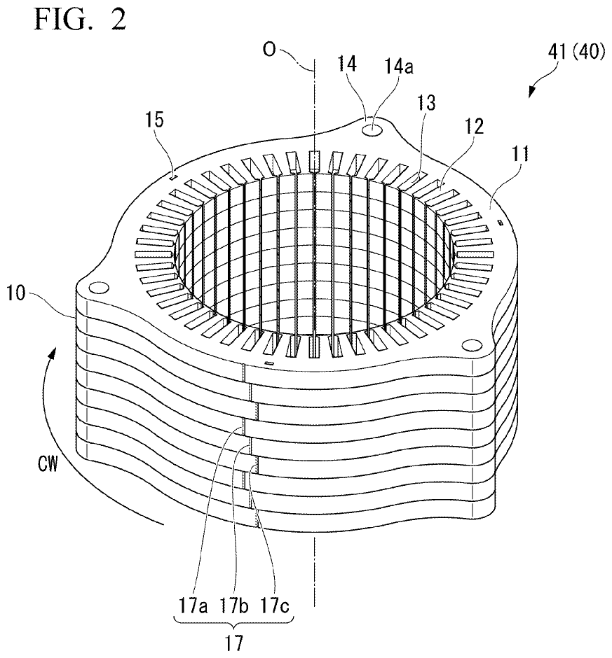

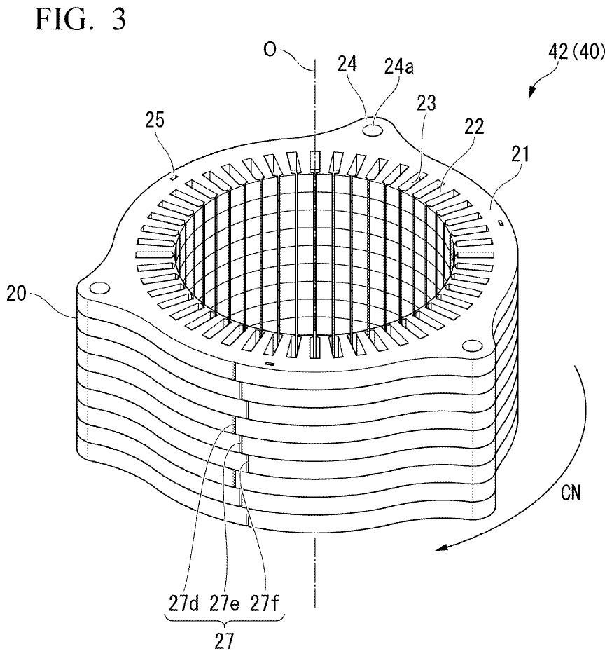

FIG. 2 is a perspective view of a first stator core 41 according to the first embodiment, and FIG. 3 is a perspective view of a second stator core 42 according to the first embodiment.

The stator core 40 is one of the first stator core 41 and the second stator core 42. The first stator core 41 is formed by laminating a plurality of first core plates 10 in a thickness direction. The second stator core 42 is formed by laminating a plurality of second core plates 20 in the thickness direction.

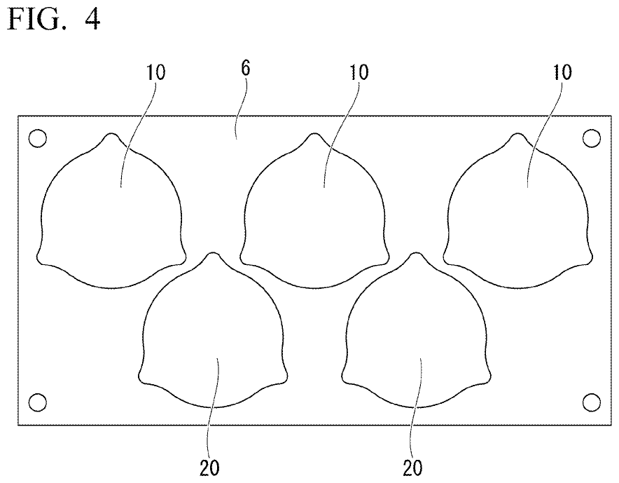

Here, FIG. 4 is an explanatory diagram showing a positional relationship between a steel plate 6 and each of the core plates 10 and 20. The steel plate 6 is, for example, an electromagnetic steel plate. The first core plate 10 and the second core plate 20 are extracted from a single steel plate 6 as a group in a plurality of rows. Specifically, the first core plates 10 are formed by performing punching from a first row of the steel plate 6. The second core plates 20 are formed by performing punching from a second row of the steel plate 6.

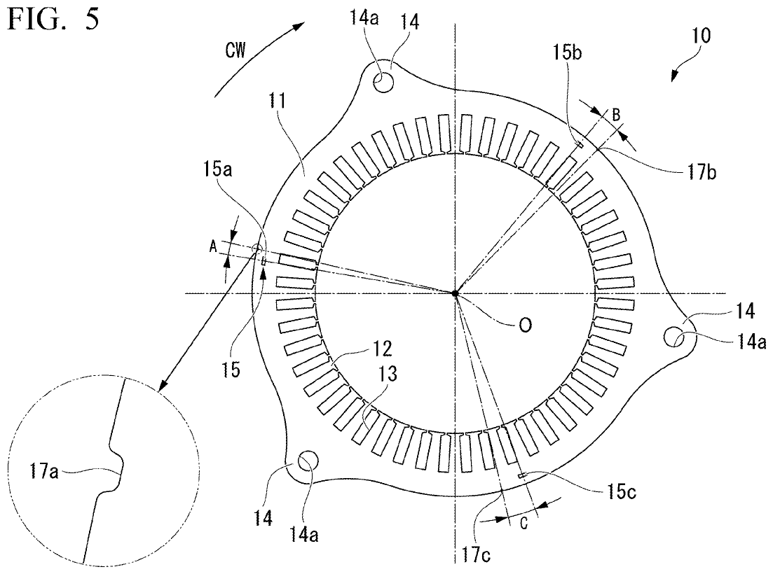

FIG. 5 is a front view of the first core plate 10.

The first core plate 10 is formed in an annular shape centered on the axis O. The first core plate 10 includes a first core main body 11, a first tooth 12, a first bolt insertion portion 14, a first caulking hole 15, and a first identification portion 17.

The first core main body 11 is formed in an annular shape.

The first tooth 12 protrudes inward from the first core main body 11 in the radial direction. A plurality of first teeth 12 are formed in the circumferential direction. A first slot 13 is formed between first teeth 12 adjacent to each other in the circumferential direction. A coil 45 is inserted into the first slot 13.

The first bolt insertion portion 14 protrudes outward from the first core main body 11 in the radial direction. A plurality of first bolt insertion portions 14 (e.g., three in the embodiment) are provided at regular intervals in the circumferential direction. A bolt hole 14a into which a bolt (not shown) can be inserted is formed in each of the first bolt insertion portions 14.

The first caulking hole 15 is provided in the first core main body 11. The first caulking hole 15 passes through the first core main body 11 in the axial direction. A plurality of first caulking holes 15 (e.g., three in the embodiment) are provided in the circumferential direction. Each of the first caulking holes 15 is provided between first bolt insertion portions 14 adjacent to each other in the circumferential direction. Here, the plurality of first caulking holes 15 are sequentially numbered from 1 to 3 around one side CW in the circumferential direction and are respectively defined as a first caulking hole 15a, a second caulking hole 15b, and a third caulking hole 15c.

The first identification portion 17 is provided on an outer peripheral portion of the first core main body 11. The first identification portion 17 is recessed inward from the outer peripheral portion of the first core main body 11 in the radial direction. The first identification portion 17 is formed in a rectangular shape when seen in the axial direction. The first identification portion 17 is provided at a position spaced apart from the first caulking hole 15 by a predetermined angle around the one side CW in the circumferential direction with the axis O as a rotation center. A plurality of first identification portions 17 (e.g., three in the embodiment) are provided in the circumferential direction.

When the plurality of first identification portions 17 are sequentially numbered from 1 to 3 around the one side CW in the circumferential direction and are respectively set to a first identification portion 17a, a second identification portion 17b, and a third identification portion 17c, each of the identification portions 17a, 17b, and 17c is provided in the vicinity of first caulking holes 15 different from each other. Specifically, the first identification portion 17a is provided at a position spaced apart from the first caulking hole 15a by an angle A around the one side CW in the circumferential direction with the axis O as the rotation center. The second identification portion 17b is provided at a position spaced apart from the second caulking hole 15b by an angle B around the one side CW in the circumferential direction with the axis O as the rotation center. The third identification portion 17c is provided at a position spaced apart from the third caulking hole 15c by an angle C around the one side CW in the circumferential direction with the axis O as the rotation center. The angles A, B, and C are different from each other. In the embodiment, A<B<C is established.

Returning to FIG. 2, the first core plates 10 formed in this way are formed into the annular first stator core 41 centered on the axis O by turning lamination in which a plurality of first core plates 10 are laminated in the axial direction and then rotated 120° in the circumferential direction to perform a next lamination. As shown in FIG. 2, the first identification portions 17 are formed on an outer peripheral portion of the first stator core 41. Specifically, the first identification portions 17 are arranged on one side surface of the first stator core 41 in the axial direction in the order of the first identification portion 17a, the second identification portion 17b, the third identification portion 17c, the first identification portion 17a, and so on. Turning lamination identification and row identification are performed by a shape of the first identification portion 17 formed on the outer peripheral portion of the first stator core 41.

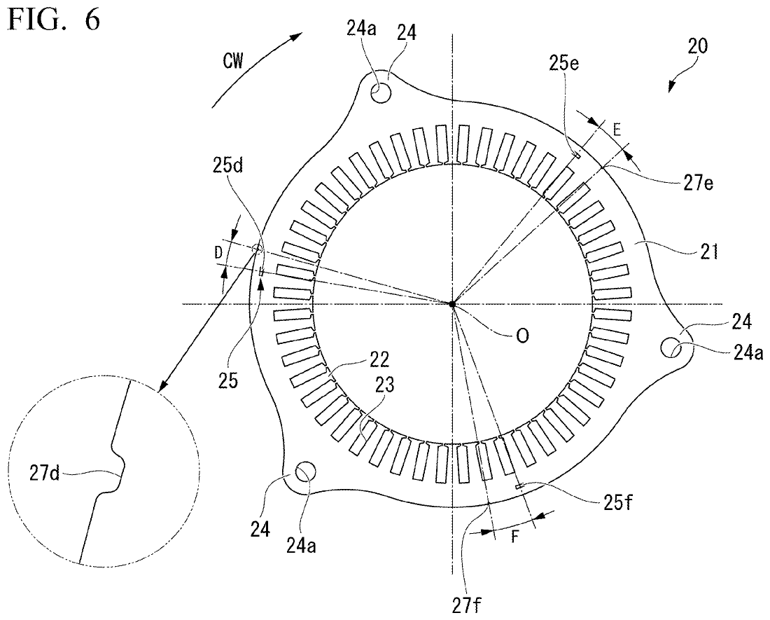

FIG. 6 is a front view of the second core plate 20.

The second core plate 20 is formed in an annular shape centered on the axis O. The second core plate 20 includes a second core main body 21, a second tooth 22, a second bolt insertion portion 24, a second caulking hole 25, and a second identification portion 27.

The second core main body 21 is formed in an annular shape.

The second tooth 22 protrudes inward from the second core main body 21 in the radial direction. A plurality of second teeth 22 are formed in the circumferential direction. A second slot 23 is formed between second teeth 22 adjacent to each other in the circumferential direction. A coil 45 is inserted into the second slot 23.

The second bolt insertion portion 24 protrudes outward from the second core main body 21 in the radial direction. A plurality of (three in the embodiment) second bolt insertion portions 24 are provided at regular intervals in the circumferential direction. A bolt hole 24a into which a bolt (not shown) can be inserted is formed in each of the second bolt insertion portions 24.

The second caulking hole 25 is provided in the second core main body 21. The second caulking hole 25 passes through the second core main body 21 in the axial direction. A plurality (three in the embodiment) of second caulking holes 25 are provided in the circumferential direction. Each of the second caulking holes 25 is provided between the second bolt insertion portions 24 adjacent to each other in the circumferential direction. Here, the plurality of second caulking holes 25 are sequentially numbered from 4 to 6 around the one side CW in the circumferential direction and are respectively defined as a fourth caulking hole 25d, a fifth caulking hole 25e, and a sixth caulking hole 25f.

The second identification portion 27 is provided on an outer peripheral portion of the second core main body 21. The second identification portion 27 is recessed inward from the outer peripheral portion of the second core main body 21 in the radial direction. The second identification portion 27 is formed in a rectangular shape when seen in the axial direction. The second identification portion 27 is provided at a position spaced apart from the second caulking hole 25 by a predetermined angle around the one side CW in the circumferential direction with the axis O as a rotation center. A plurality of (three in the embodiment) second identification portions 27 are provided in the circumferential direction.

When the plurality of second identification portions 27 are sequentially numbered from 4 to 6 around the one side CW in the circumferential direction and are respectively set to a fourth identification portion 27d, a fifth identification portion 27e, and a sixth identification portion 27f, each of the identification portions 27d, 27e, and 27f is provided in the vicinity of second caulking holes 25 different from each other. Specifically, the fourth identification portion 27d is provided at a position spaced apart from the fourth caulking hole 25d by an angle D around the one side CW in the circumferential direction with the axis O as the rotation center. The fifth identification portion 27e is provided at a position spaced apart from the fifth caulking hole 25e by an angle E around the one side CW in the circumferential direction with the axis O as the rotation center. The sixth identification portion 27f is provided at a position spaced apart from the sixth caulking hole 25f by an angle F around the one side CW in the circumferential direction with the axis O as the rotation center. The angles D, E, and F are different from each other. In the embodiment, D<E<F is established. Further, the angles D, E, and F are different from the angles A, B, and C in the first core plate 10. In the embodiment, A<D, B<E, and C<F are established.

Returning to FIG. 3, the second core plates 20 formed in this way are formed into the annular second stator core 42 centered on the axis O by turning lamination in which a plurality of second core plates 20 are laminated in the axial direction and then rotated 120° in the circumferential direction to perform a next lamination. As shown in FIG. 3, the second identification portions 27 are formed on an outer peripheral portion of the second stator core 42. Specifically, the second identification portions 27 are arranged on one side surface of the second stator core 42 in the axial direction in the order of the fourth identification portion 27d, the fifth identification portion 27e, the sixth identification portion 27f, the fourth identification portion 27d, and so on. In the embodiment, the constitution of the second stator core 42 (other than the position of the second identification portion 27) is formed to be the same as that of the first stator core 41. The turning lamination identification and the row identification are performed by a shape of the second identification portion 27 formed on the outer peripheral portion of the second stator core 42.

The coil 45 is inserted into the first slot 13 and wound around the first tooth 12 in the first stator core 41. Similarly, the coil 45 is inserted into the second slot 23 and wound around the second tooth 22 in the second stator core 42. A magnetic attractive force or repulsive force is generated between the coil 45 and the magnet 33 accommodated in the rotor 3 by energizing the coil 45, and the rotor 3 rotates around the axis O with respect to the stator 4.

### Operation and Effects

Next, an operation and effects of the stator core 40 and the rotating electric machine 1 will be described.

As shown in FIGS. 2 and 3, the first identification portion 17 formed on the outer peripheral portion of the first stator core 41 and the second identification portion 27 formed on the outer peripheral portion of the second stator core 42 have different positions in the circumferential direction. Specifically, in one side surface of the stator core 40 sandwiched between the two bolt insertion portions 14, 14, 24, and 24, the second identification portion 27 is located on the one side CW in the circumferential direction with respect to the first identification portion 17. It is possible to identify which row of the steel plate 6 the stator core 40 has been extracted from by forming the first identification portion 17 and the second identification portion 27 at different positions in the circumferential direction as described above.

On the other hand, as shown in FIG. 2, the first identification portion 17a, the second identification portion 17b, and the third identification portion 17c are formed in this order in the axial direction on one side surface of the first stator core 41 sandwiched between the two first bolt insertion portions 14 and 14. Specifically, the second identification portion 17b provided on one side (the lower side of FIG. 2) of the first identification portion 17a in the axial direction is located on the other side (the side opposite to CW) in the circumferential direction with respect to the first identification portion 17a. The third identification portion 17c provided on one side of the second identification portion 17b in the axial direction is located on the other side in the circumferential direction with respect to the second identification portion 17b. It is possible to confirm whether or not the turning lamination has been performed correctly by visually checking whether or not the first identification portion 17a, the second identification portion 17b, and the third identification portion 17c are regularly arranged.

According to the stator core 40 of the embodiment, since each of the first identification portion 17 and the second identification portion 27 serves as turning lamination identification and row identification, it is possible to identify, by the first identification portion 17 and the second identification portion 27, whether or not the turning lamination has been performed correctly and which row of the steel plate 6 the core plate group has been extracted from. Since each of the first identification portion 17 and the second identification portion 27 serves as row identification, it is not necessary to provide a cutout shape or the like for row identification additionally in the stator core 40. Thus, the number of processes for manufacturing the stator core 40 and manufacturing costs such as mold costs can be reduced, as compared with a case in which both a turning lamination identification shape and a row identification shape are formed on the stator core 40. Furthermore, since it is not necessary to form an extra cutout or the like which obstructs formation of a magnetic path in the stator core 40, an area of the stator core 40 can be increased, and thus an area through which the magnetic path passes can be increased. Accordingly, a decrease in performance of the stator 4 due to the obstruction of the magnetic path of the stator core 40 can be curbed.

Since the first identification portion 17 and the second identification portion 27 are formed in the outer peripheral portion of the stator core 40, when a plurality of core plates 10 and 20 are turned and laminated in the thickness direction, the identification portion can be visually recognized from the outer peripheral portion of the stator core 40. Therefore, determination as to whether or not turning lamination has been performed correctly can be easily confirmed from the outside. Thus, workability at the time of manufacturing the stator core 40 can be improved.

Therefore, it is possible to provide the stator core 40 which can be easily manufactured while an increase in manufacturing costs and a decrease in performance are curbed.

Since the first identification portion 17 and the second identification portion 27 are recessed inside the stator core 40, the outer peripheral portion of the stator core 40 formed by turning and laminating the plurality of core plates 10 and 20 can have a smooth shape, as compared to a case in which the first identification portion 17 and the second identification portion 27 protrude outward. Thus, operability at the time of manufacture and an external appearance can be improved.

According to the rotating electric machine 1 of the embodiment, since the above-described stator core 40 is provided, it is possible to provide the rotating electric machine 1 having excellent manufacturability and performance and including the stator core 40 which is easily manufactured while an increase in manufacturing costs and a decrease in performance are curbed.

### Second Embodiment

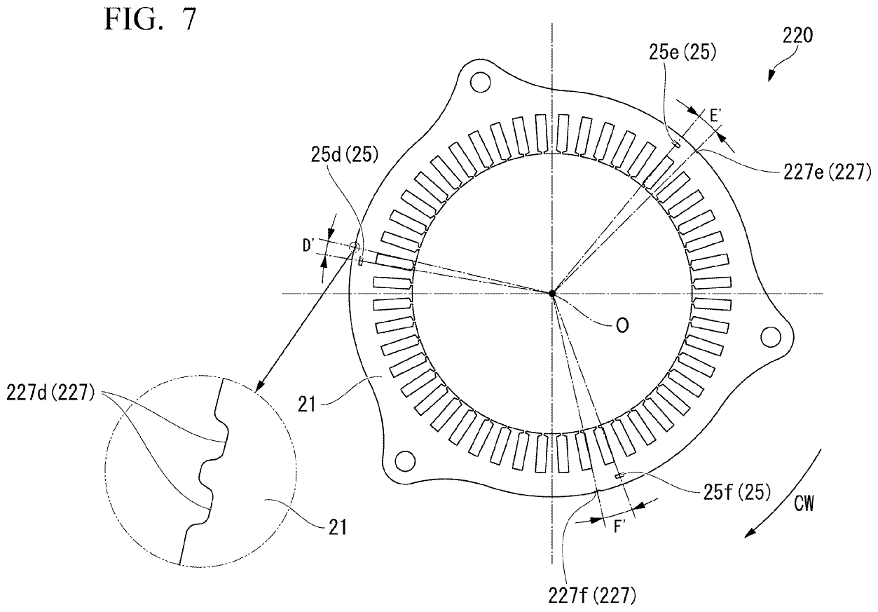

Next, a second embodiment according to the present invention will be described. FIG. 7 is a front view of a second core plate 220 according to the second embodiment. The embodiment is different from the above-described embodiment in that shapes of the first identification portion 17 and the second identification portion 27 are different from each other.

In the embodiment, since the first core plate 10 has the same constitution as that of the first embodiment, description of the first core plate 10 will be omitted. The second core plate 220 has a pair of second identification portions 227 constituted by two concave portions. Each of the pair of second identification portions 227 is formed in a rectangular shape when seen in the axial direction. The pair of second identification portions 227 are provided at positions spaced apart from the second caulking hole 25 by a predetermined angle around one side CW in the circumferential direction. A plurality of (three in the embodiment) pairs of second identification portions 227 are provided in the circumferential direction. The pair of concave portions are formed close to each other.

As shown in FIG. 7, a fourth identification portion 227d in the second core plate 220 is provided at a position spaced apart from the fourth caulking hole 25d by an angle D′ around the one side CW in the circumferential direction with the axis O as a rotation center. A fifth identification portion 227e is provided at a position spaced apart from the fifth caulking hole 25e by an angle E′ around the one side CW in the circumferential direction with the axis O as a rotation center. A sixth identification portion 227f is provided at a position spaced apart from the sixth caulking hole 25f by an angle F′ around the one side CW in the circumferential direction with the axis O as a rotation center. In the embodiment, D′=A, E′=B, and F′=C. The angles D′, E′, and F′ may be set to values different from those of the angles A, B, and C in the first stator core 10.

According to the embodiment, since the shapes of the first identification portion 17 and the second identification portion 227 are different from each other, identification of the first stator core 41 and the second stator core 42, that is, row identification can be performed. Further, since the first identification portion 17 and the second identification portion 227 serves as the row identification and the turning lamination identification, it is possible to identify, by the first identification portion 17 and the second identification portion 227, whether or not the turning lamination has been performed correctly and which row of the steel plate 6 the core plate group has been extracted from. Furthermore, a weight of the second stator core 42 can be reduced.

### Third Embodiment

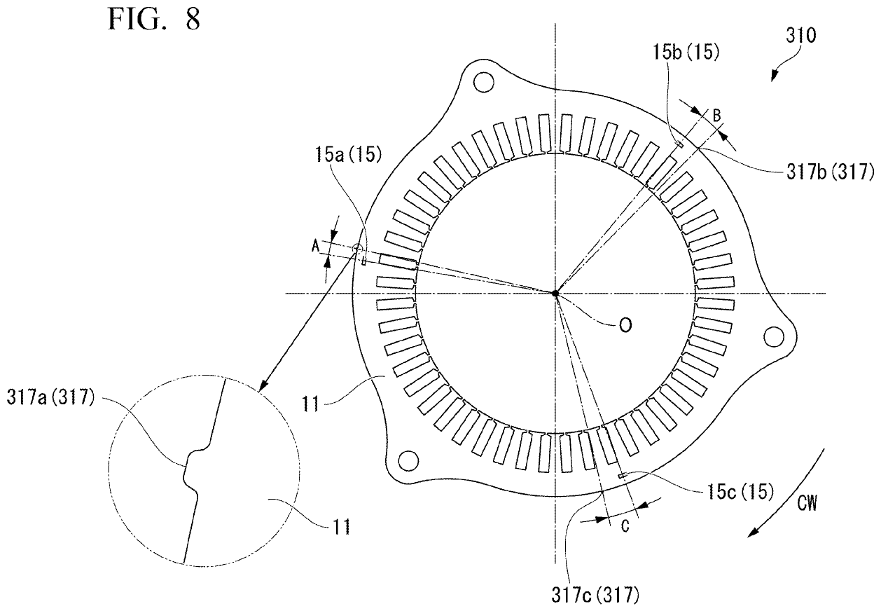

Next, a third embodiment according to the present invention will be described. FIG. 8 is a front view of a first core plate 310 according to the third embodiment. The embodiment is different from the above-described embodiment in that the identification portion protrudes outside the stator core 40. In the embodiment, since the second core plate 20 is modified in the same manner as that in the first core plate 10, description and illustration of the second core plate 20 will be omitted below.

In the embodiment, the first core plate 310 has a first identification portion 317. The first identification portion 317 protrudes outward from the outer peripheral portion of the first core main body 11 in the radial direction. An external appearance of the first identification portion 317 is formed in a rectangular shape.

According to the embodiment, since the identification portion protrudes outside the stator core 40, it is possible to perform the row identification and the turning lamination identification only by touching the outer peripheral portion of the stator core 40 formed by turning and laminating the plurality of core plates 310. In addition, a degree of freedom of an identification work method can be improved, for example, by automating the identification work using a contact type inspection device.

Further, the area of the stator core 40 can be ensured as compared with a case in which the identification portion is formed to be recessed inside the stator core 40. Thus, the area through which the magnetic path formed in the stator 4 can pass is increased, and an influence on the magnetic path due to the formation of the identification portion can be curbed.

### Fourth Embodiment

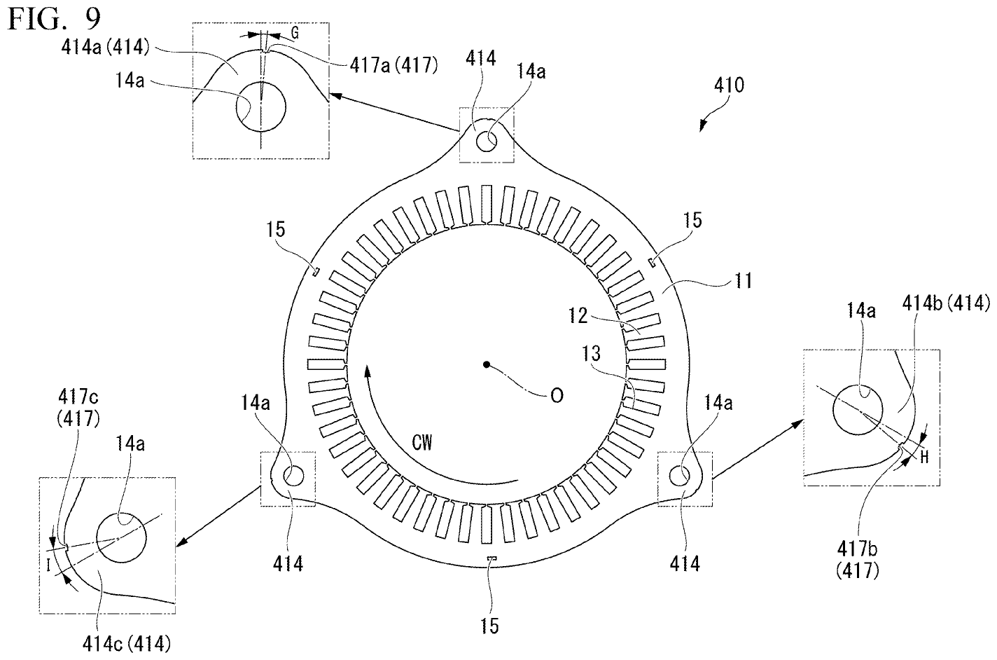

Next, a fourth embodiment according to the present invention will be described. FIG. 9 is a front view of a first core plate 410 according to the fourth embodiment. The embodiment is different from the above-described embodiment in that the identification portion is provided in the bolt insertion portion 14.

In the embodiment, the first core plate 410 has a first identification portion 417. As shown in FIG. 9, the first identification portion 417 is provided in the first bolt insertion portion 414. The first identification portion 417 is recessed inward from an outer peripheral portion of the first bolt insertion portion 414 in the radial direction. Here, when a plurality of first bolt insertion portions 414 are sequentially numbered from 1 to 3 around the one side CW in the circumferential direction and are respectively set to a first bolt insertion portion 414a, a second bolt insertion portion 414b, and a third bolt insertion portion 414c, the first identification portion 417 is provided at a different position in each of the bolt insertion portions 414a, 414b, and 414c. Specifically, a first identification portion 417a is provided at a position spaced apart from an intersection between a straight line which connects the axis O to a circle center of the first bolt insertion portion 414a and an outer peripheral portion of the first bolt insertion portion 414a by an angle G around the one side CW in the circumferential direction with the circle center of the first bolt insertion portion 414a as a rotation center. A second identification portion 417b is provided at a position spaced apart from an intersection between a straight line which connects the axis O to a circle center of the second bolt insertion portion 414b and an outer peripheral portion of the second bolt insertion portion 414b by an angle H around the one side CW in the circumferential direction with the circle center of the second bolt insertion portion 414b as a rotation center. A third identification portion 417c is provided at a position spaced apart from an intersection between a straight line which connects the axis O to a circle center of the third bolt insertion portion 414c and an outer peripheral portion of the third bolt insertion portion 414c by an angle I around the one side CW in the circumferential direction with the circle center of the third bolt insertion portion 414c as a rotation center. The angles G, H, and I have values different from each other.

In the embodiment, since the second core plate 20 is modified in the same manner as that in the first core plate 410, detailed description and illustration of the second core plate 20 will be omitted. In the second core plate 20 according to the embodiment, the angles of portions of the first core plate 410 corresponding to the angles G, H, and I are respectively set to J, K, and L. At this time, G<J, H<K, and I<L are set.

According to the embodiment, since the first identification portion 417 is provided in the first bolt insertion portion 414, it is not necessary to provide the first identification portion 417 in the first core main body 11. Therefore, an area of the first core main body 11 can be increased, and a passage area of the magnetic path formed in the first core main body 11 can be increased. Thus, it is possible to further curb the decrease in performance of the stator 4 due to the magnetic path being obstructed.

The technical scope of the present invention is not limited to the above-described embodiments, and various modifications can be made without departing from the subject matter of the present invention.

For example, in the embodiment, two rows of core plates 10 and 20 are extracted from the single steel plate 6, but the present invention is not limited thereto. For example, three or more rows of core plates may be extracted from the single steel plate 6.

Further, the first identification portion 17 and the second identification portion 27 may be formed so that both positions and shapes thereof are mutually differ.

The shape of the first identification portion 17 and the second identification portion 27 may be formed in shapes, such as a semicircle shape and a triangle shape, other than the rectangular shape.

Moreover, the number of the bolt insertion portions 14 and 24, the caulking holes 15 and 25, or the identification portions 17 and 27 is not limited to the above-described embodiments.

In addition, it is possible to appropriately replace constituent elements in the above-described embodiments with well-known constituent elements without departing from the subject matter of the present invention, and the above-described modified examples may be combined as appropriate.

What is claimed is:

1. A stator core having a core plate group extracted as a group in a plurality of rows from a single steel plate, comprising:
an identification portion provided on an outer periphery of the stator core and serving as turning lamination identification and row identification,
wherein at least one of a shape and a position of the identification portion in the stator core having at least one row of the core plate group is different from that in the stator core having another row of the core plate group.

2. The stator core according to claim 1, wherein the identification portion is recessed inside the stator core.

3. The stator core according to claim 1, wherein the identification portion protrudes outside the stator core.

4. A rotating electric machine comprising the stator core according to claim 1.
